(19) United States
(12) Patent Application Publication
(10) Pub. No.: US 2006/0085996 A1
(43) Pub. Date: Apr. 27, 2006

(54) Clothing dryer

(75) Inventor: Seong Ha Hwang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/176,210

(22) Filed: Jul. 8, 2005

(30) Foreign Application Priority Data
Oct. 25, 2004 (KR) 2004-85360

(51) Int. Cl. F26B 21/06; F26B 11/02

(52) U.S. Cl. 34/82; 34/606

(57) ABSTRACT

A clothing dryer capable of removing impurities contained in air being introduced into a drying tub. The clothing dryer includes a filter mounted in an air inlet port of the drying tub for drying wet clothing, so as to filter impurities, such as dust, lint, etc., contained in the air being introduced into the drying tub via the air inlet port.

### CROSS-REFERENCE TO RELATED APPLICATION

This application claims priority from Korean Patent Application No. 2004-85360, filed on Oct. 25, 2004 in the Korean Intellectual Property Office, the disclosure of which is incorporated herein by reference.

### BACKGROUND OF THE INVENTION

1. Field of the Invention

The present invention relates to a clothing dryer and, more particularly, to a clothing dryer which can remove impurities contained in air being introduced into a drying tub.

2. Description of the Related Art

In general, clothing dryers are machines which forcibly blow hot air into a drying tub, so as to dry wet clothing put in the drying tub. Such clothing dryers use a blowing fan and a heater in order to achieve drying of the wet clothing through forced circulation of the heated high-temperature air into the drying tub.

A conventional example of the above-noted clothing dryers comprises: a housing provided at its front surface with a door; a cylindrical drying tub mounted in the housing to extend lengthwise across a relatively long distance; a hot air inlet duct connected at its one end to a rear side of the drying tub and incorporating a heater to guide hot air, heated by the heater, into the drying tub; and a hot air outlet duct incorporating a blowing fan to inhale the hot air from the drying tub to thereby discharge it to the outside. As the blowing fan rotates, the air is introduced into the hot air inlet duct, and then is supplied into the drying tub after being heated to a high temperature inside the hot air inlet duct, serving to dry wet clothing received in the drying tub, and being discharged to the outside via the hot air outlet duct.

The above described conventional clothing dryer, however, has a problem in that it has no means to remove impurities, such as dust, lint, etc. contained in the air being introduced into the drying tub. If such impurities or bacteria are introduced into the drying tub, it may contaminate the clothing in the drying tub.

### SUMMARY OF THE INVENTION

Therefore, the present invention has been made in order to solve the above problem, and it is an aspect of the invention to provide a clothing dryer capable of removing impurities contained in air being introduced into a drying tub.

Additional aspects and/or advantages of the invention will be set forth in part in the description which follows and, in part, will be apparent from the description, or may be learned by practice of the invention.

In accordance with one aspect, the present invention provides a clothing dryer comprising a drying tub for drying wet clothing, wherein a filter is provided at an air inlet port of the drying tub to remove impurities from air being introduced into the drying tub via the air inlet port.

The air inlet port may be further internally provided with: an introduction grill to support a rear end of the filter and formed with communicating holes to permit passage of the air; and a filter cover disposed at a front side of the filter to allow the filter to be detachably mounted in the air inlet port.

The filter cover may have: a frame portion defining a rim portion of the filter cover to keep a predetermined shape of the filter cover; and a grill portion having a lattice pattern to permit the air to pass therethrough.

A rear panel, defining a rear surface of the drying tub and partially opened to form the air inlet port, may be formed with a latch recess for the installation of the filter cover at a position close to the air inlet port, and the filter cover may further have: a latch protrusion formed at a side of the filter cover to be inserted and latched in the latch recess; and clamps formed at an opposite side of the filter cover to be affixed to the rear panel by fastening members which are fastened thereto.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is a longitudinal sectional view showing schematic configuration of a clothing dryer consistent with the present invention; and

FIG. 2 is an exploded perspective view showing a filter installation structure of the clothing dryer consistent with the present invention.

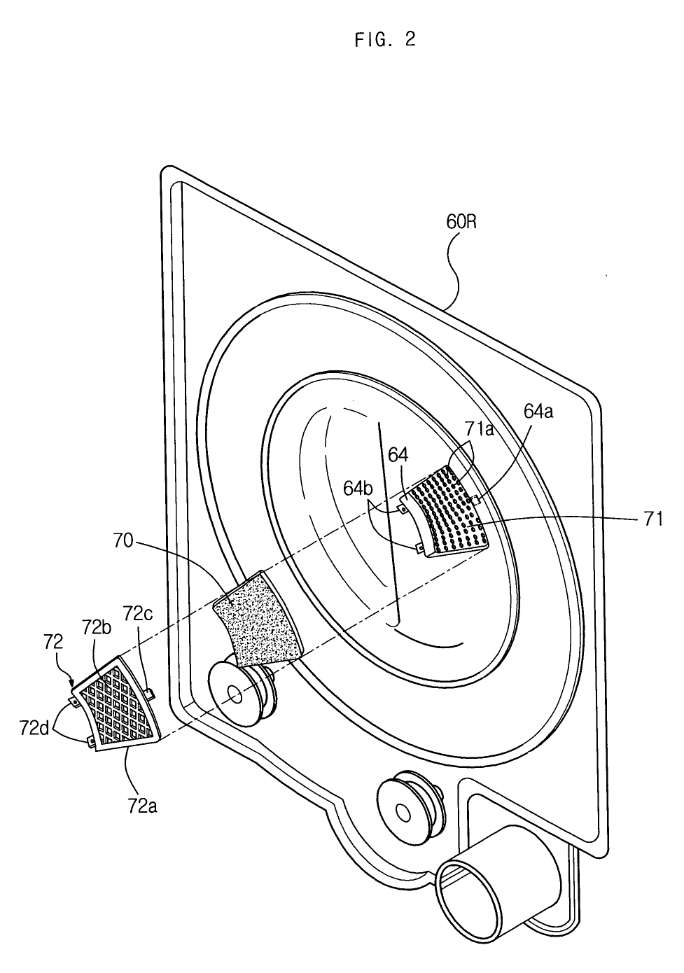

### DETAILED DESCRIPTION OF THE ILLUSTRATIVE, NON-LIMITING EMBODIMENTS OF THE INVENTION

Reference will now be made in detail to an illustrative, non-limiting embodiment of the present invention, examples of which are illustrated in the accompanying drawings, wherein like reference numerals refer to like elements throughout. The embodiment is described below to explain the present invention by referring to the figures.

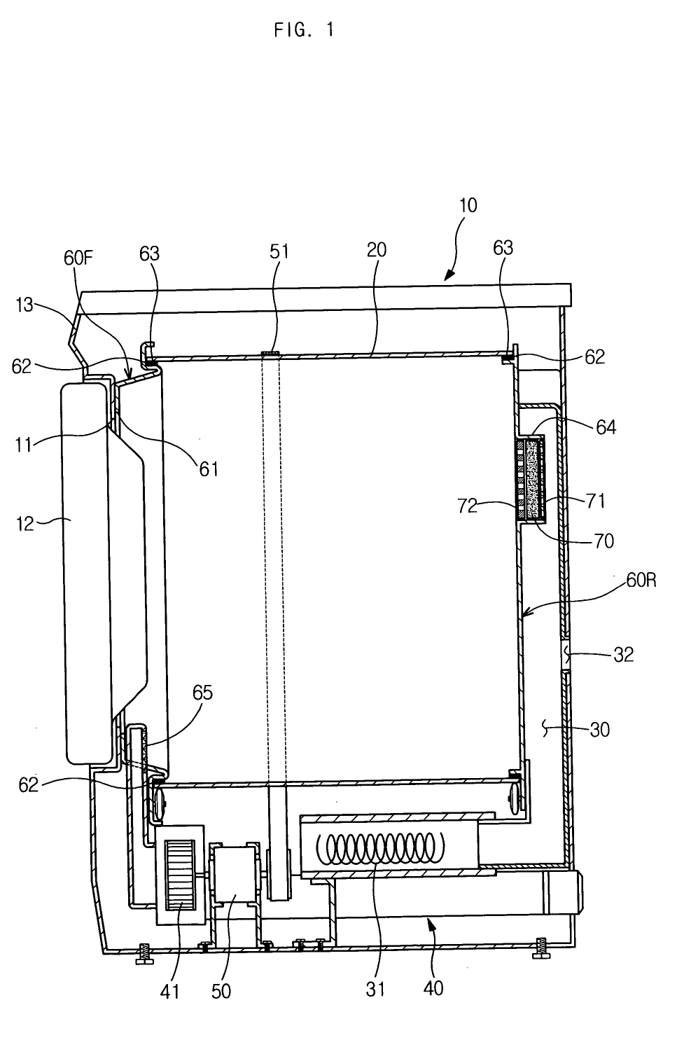

FIG. 1 is a longitudinal sectional view showing the schematic configuration of a clothing dryer consistent with the present invention. As shown in FIG. 1, the clothing dryer comprises: a housing 10 forming an external appearance of the clothing dryer; a drum-shaped drying tub 20 rotatably mounted in the housing 10; a hot air inlet duct 30 to guide hot air into the drying tub 20; and a hot air outlet duct 40 to guide the hot air, discharged from the drying tub 20, so as to be discharged to the outside.

The housing 10 is formed at a front surface thereof with an opening 11 to put wet clothing into or take clothing out of the housing 10, and a door 12 is hinged at a lateral side of the opening 11 to open or close the opening 11. At an upper portion of the front surface of the housing 10 is disposed a control panel 13, which has operating buttons (not shown) to control the general operation of the clothing dryer and a display unit (not shown) to display operational modes of the clothing dryer.

The drying tub 20 is rotatably supported in the housing 10, and is adapted to rotate using a rotating force transmitted from a drive motor 50, mounted in a lower region of the housing 10, by way of a belt 51, enabling uniform drying of the wet clothing received therein.

The hot air inlet duct 30 incorporates a heater 31 to heat air flowing through the interior of the inlet duct 30. The hot air inlet duct 30 has an end opened toward an interior space of the housing 10, and the other end connected to the drying tub 20 so as to supply the hot air into the drying tub 20. At the hot air inlet duct 30 is medially formed an auxiliary inlet hole 32, which is opened rearward to the housing 10, to directly introduce outside air into the hot air inlet duct 30. In this way, the hot air inlet duct 30 is capable of directly receiving the outside air, not heated by the heater 31.

The hot air outlet duct 40 incorporates a blowing fan 41 to generate a blowing force necessary to introduce and discharge the hot air. The hot air outlet duct 40 has an end located forward to the drying tub 20, and the other end penetrating through a rear surface of the housing 10 to be opened to the outside to thereby discharge the hot air from the rear side of the housing 10.

With such a configuration as stated above, the hot air, heated in the hot air inlet duct 30 by means of the heater 31, is introduced into the drying tub 20 via the hot air inlet duct 30 by making use of the blowing force generated by the blowing fan 41. Thereby, after being used to dry the wet clothing received in the drying tub 20, the hot air is discharged to the outside via the hot air outlet duct 40.

The drying tub 20 has a front panel 60F defining a front surface of the drying tub 20 and adapted to rotatably support a front end of the drying tub 20, and a rear panel 60R defining a rear surface of the drying tub 20 and adapted to rotatably support a rear end of the drying tub 20. The front panel 60F is formed with a through-hole 61 to put the clothing into or take it out of the drying tub 20.

Both the front panel 60F and the rear panel 60R are provided with annular supporting members 62 protruding inward from their facing inner surfaces. The supporting members 62, having such an annular form, are configured to rotatably support inner circumferences of front and rear ends of the drying tub 20 at their outer circumferences. Around the outer circumference of a respective one of the supporting members 62 is disposed a friction reducing pad 63 having a low frictional coefficient. That is, both the front and rear ends of the drying tub 20 are supported by the two supporting members 62 by interposing the friction reducing pads 63, respectively. With such a configuration, when the rotating force from the drive motor 50 is transmitted to the drying tub 20, both the front and rear ends of the drying tub 20 are slid on surfaces of the friction reducing pads 63 disposed around the supporting members 62, causing rotation thereof.

To the rear panel 60R is mounted the hot air inlet duct 30 to guide the hot air into the drying tub 20, so that the hot air from the hot air inlet duct 30 is transmitted to the rear panel 60R. On the other hand, to the front panel 60F is mounted the hot air outlet duct 40 to discharge the hot air to the outside. Thereby, the hot air flows from a rear region of the drying tub 20 associated with the hot air inlet duct 30 to a front region of the drying tub 20 associated with the hot air outlet duct 40 thereby to pass through outlet openings 65, serving to dry the wet clothing in the drying tub 20.

In order to allow the hot air, passed through the hot air suction duct 30, to be introduced into the drying tub 20, the rear panel 60R is partially opened to form an inlet port 64. Inside the inlet port 64 is mounted a filter 70 in order to remove impurities, such as dust, lint, etc., from air existing inside the housing 10 or the hot air introduced via the auxiliary inlet hole 32 to pass through the hot air inlet duct 30. It will be recognized that the air, introduced via the auxiliary inlet hole 32, is quite probable to contain bacteria since it does not pass through the heater 31. Therefore, the filter 70 preferably, but not necessarily, has a sterilizing function in addition to a function of filtering dust, lint, etc.

Inside the inlet port 64 is further mounted an introduction grill 71, which serves to support a rear end of the filter 70. The introduction grill 71 has a plurality of communicating holes 71a to pass the hot air so as to be introduced into the drying tub 20. In this case, the introduction grill 71 must be made of a heat resistant metal material since it is heated to a high temperature by the hot air passing therethrough.

As will be expected, the performance of the filter 70 is degraded with the passage of time due to the accumulated dust and lint, requiring periodical cleaning or exchange of the filter 70. Therefore, the filter 70 according to the present invention is detachably mounted in the inlet port 64, so that it can be easily separated from the inlet port 64 for the cleaning or exchange thereof when it is determined that the filter 70 is contaminated beyond an allowable range.

For this, a filter cover 72 is detachably fitted to the rear panel 60R to cover a front surface of the filter 70. The filter cover 72 has a shape corresponding to the shape of the inlet port 64, and is rimmed by a frame portion 72a to keep a predetermined shape of the filter cover 72. Inside the frame portion 72a is fitted a grill portion 72b having a lattice pattern to permit the air to pass therethrough.

In order to detachably mount the filter 70 in the inlet port 64, the filter cover 72 has a latch protrusion 72c, and clamps 72d. The latch protrusion 72c is provided at a side of the filter cover 72 and configured to be latched and supported by an associated portion of the rear panel 60R adjacent to the inlet port 64. The clamps 72d are formed at an opposite side of the filter cover 72 to affix the opposite side of the filter cover 72 to the rear panel 60R as fastening members, such as bolts, are fastened thereto. Correspondingly, the rear panel 60R is formed with a latch recess 64a for the insertion of the latch protrusion 72c and seating recesses 64b for the insertion of the respective clamps 72d. With such a configuration, after the latch protrusion 72c is inserted in the latch recess 64a and the clamps 72d are seated in the seating recesses 64b, the clamps 72d are affixed in the seating recesses 64b as the fastening members, i.e. bolts, are fastened thereto. In this way, the filter 70 is detachably mounted inside the inlet port 64 by means of the filter cover 72.

As apparent from the above description, the present invention provides a clothing dryer provided with a filter at an inlet port to guide air into a drying tub, thereby removing impurities contained in the air being introduced into the drying tub.

Although exemplary embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A clothing dryer comprising a drying tub for drying wet clothing, wherein a filter is provided at an air inlet port of the drying tub to remove impurities from air being introduced into the drying tub via the air inlet port.

2. The clothing dryer according to claim 1, wherein the air inlet port is further internally provided with:
an introduction grill to support a rear end of the filter and formed with communicating holes to permit passage of the air; and
a filter cover disposed at a front side of the filter to allow the filter to be detachably mounted in the air inlet port.

3. The clothing dryer according to claim 2, wherein the filter cover has:
a frame portion defining a rim portion of the filter cover to keep a predetermined shape of the filter cover; and
a grill portion having a lattice pattern to permit the air to pass therethrough.

4. The clothing dryer according to claim 2, wherein a rear panel, defining a rear surface of the drying tub and partially opened to form the air inlet port, is formed with a latch recess for the installation of the filter cover at a position close to the air inlet port, and
wherein the filter cover further has:
a latch protrusion formed at a side of the filter cover to be inserted and latched in the latch recess; and
clamps formed at an opposite side of the filter cover to be affixed to the rear panel by fastening members which are fastened thereto.
